(19) United States
(12) Patent Application Publication
(10) Pub. No.: US 2004/0078630 A1
(43) Pub. Date: Apr. 22, 2004

(54) System and method for protecting data

(76) Inventors: Ronald Steven Niles, Teaneck, NJ (US); Sheng-Wei Chen, Hauppauge, NY (US)

Correspondence Address: Gregory A. Silberman U.S. P.T.O., Kaye Scholer LLP, 425 Park Avenue, New York, NY, 10022, US

(21) Appl. No.: 10/186,061

(22) Filed: Jun. 28, 2002

(51) Int. Cl. G06F 11/00

(52) U.S. Cl. 714/5

(57) ABSTRACT

A method for protecting data on storage devices, called Logical UNit (LUN) intercept, intercepts commands and/or data sent by a computer to an original, attached storage device, analyzes the commands and/or data, and performs storage operations on a secondary storage device based on the intercepted commands and data. Examples of actions used to protect data are data mirroring and data replication. This method does not disrupt the data that are stored or will be stored on the original storage device. The intercepted storage commands are analyzed, and additional storage operations are performed either immediately or at a later time on the secondary data storage device. After analysis, the original storage commands are still sent to the original storage device for execution. A system for protecting data includes an interceptor to intercept the storage commands and data. The interceptor is inserted into the communication path between the computer and the original data storage device. The interceptor thus becomes the recipient of the storage commands and data, and then becomes the actual transmitter of the storage commands and data that are received by the original and secondary data storage devices.

### BACKGROUND OF THE INVENTION

This invention relates generally to a system and method for storing data. More particularly, this invention relates to protecting stored data efficiently.

In a typical computer environment, SCSI (small computer system interface) or Fibre Channel cables directly connect a computer to its storage devices. Over time, gigabytes worth of data are written to and retrieved from the storage devices. As more data are exchanged with the storage devices, it becomes increasingly difficult for the data owner to reproduce these data if the storage devices fail. One way of protecting data is by backing up the data to tape. However, although the data is protected and is restorable, it may take many hours to restore the data, which translates into many man-hours of work lost waiting for the data to be restored.

An improvement in protecting data is to mirror and/or replicate the data onto secondary online storage devices. Mirroring is a process in which data that is written to a primary storage device is also written to a secondary storage device at the same time. Replication involves copying data from a primary storage device to a secondary storage device at different times. The benefit of these two processes is if the primary data storage device fails, the secondary storage device will either automatically or manually be brought online to service the attached computers or data servers. (A data server is a central computer whose main function is to distribute and store data for many other workstations and servers on a computer network. A data server can be a file server, application server, video server, etc.) The mirrored copy is current up to the last time the primary storage device was written to, while the replicated copy is only up-to-date as of the last time a replicated copy was made.

Although replicated data and backed-up data share the same advantage in that both make a copy of data from an earlier time period, replicated data has the added advantages that it is available online and is generally made much earlier than the backup copy. Backup of data is generally performed offline and must be restored back to a storage device before users can access it.

Although mirroring data has advantages over both replicating and backing up data, mirroring can be an expensive proposition for many businesses. Because the primary storage device and the mirrored device must communicate with each other, many storage vendors require users to either purchase an identical storage system or a same-vendor storage system. These storage systems tend to be very expensive. Another way to implement mirroring is to require data to be transferred from a storage system with no mirroring capabilities to a different storage system with mirroring capabilities. This process is time consuming, especially if the original storage system contains a large amount of data and must check the integrity of the copied data.

### SUMMARY OF THE INVENTION

The limitations of these prior art methods of copying data can be avoided by using a novel method called “Logical UNit (LUN) intercept.” LUN intercept “intercepts” storage commands and data that are sent from a computer or data server to an original, attached data storage device and performs storage operations on a secondary storage device based on the intercepted commands and data. This method does not disrupt the data that are stored or will be stored on the original storage device. The intercepted storage commands are analyzed, and additional storage operations are performed either immediately or at a later time on the secondary data storage device. After analysis, the original storage commands are still sent to the original storage device for execution. The interception of the storage commands and data is accomplished by inserting an “interceptor” into the communication path between the computer and the original data storage device. The interceptor thus becomes the recipient of the storage commands and data, and then becomes the actual transmitter of the storage commands and data that are received by the original and secondary data storage devices.

More particularly, a method of the present invention intercepts a communication from a computer destined for a first storage device, such as a disk drive, analyzes the information within the communication, and determines whether an action is to be taken regarding the first storage device, a second storage device, or both storage devices. Examples of actions taken (or tasks performed) are data mirroring and data replication. For each of these actions, many commands or requests can be sent from the computer. Examples of these commands are “inquiry,” “write,” and “read” commands. Several aspects of this invention are that the data on the first storage device are not modified by the specific action, the communication that was originally destined for the first storage device does get transmitted to that device, after interception, and a new communication is transmitted to the second storage device. This new communication is based on the action and the communication originally destined for the first storage device.

For a data mirroring action, if the command is an “inquiry,” after the command is intercepted from the computer, the same command is transmitted to the first storage device. If the command is a “write,” the “write” command is transmitted to the first storage device, an equivalent write command suitable for the second storage device is generated, and the equivalent command is transmitted to the second storage device. If the command is a “read,” it is determined whether the read command should be executed on the first or the second storage device. If to the first storage device, the same command is transmitted to the first storage device; if to the second storage device, an equivalent read command suitable for the second storage device is generated, and the equivalent command is transmitted to the second storage device.

These commands are treated similarly for a replication action, however the time frame may be different. After interception, an inquiry command is transmitted to the first storage device. A write command is transmitted to the first storage device, but an equivalent write command is generated and transmitted only after some time to the second storage device. A read command can be transmitted to either the first or the second storage device, however, it is possible that the data to be read is only available on the first storage device because the data have not yet been replicated to the second storage device.

In accordance with the invention, after the commands are transmitted to the first and/or second storage devices, the interceptor reports the results of the commands to the computer.

The communications may operate under a Fibre Channel, SCSI, or iSCSI protocol, or some other suitable storage protocol. It is also possible for the communication from the computer destined for the first storage device to operate under one protocol and for the actual commands that are sent from the interceptor to the first and/or second storage devices to operate under a different protocol, and may include command data blocks or CDBs.

Another method in accordance with the invention places an apparatus in a t communication path between a computer and an associated storage device, intercepts a communication intended for the storage device, and transmits the communication to the storage device. In a further aspect, the method attaches a second storage device to the apparatus, analyzes the information within the communication, and transmits a new communication to the second storage device. These communications can include commands and/or data, and therefore “transmitting” also includes executing the commands on the storage devices.

A system of the present invention includes a computer in communication with a storage device via a communication path and an apparatus placed in the communication path between the computer and the storage device. The apparatus intercepts a communication intended for the storage device and transmits the communication to the storage device. In a further aspect of the invention, the system includes a second storage device in communication with the apparatus, and the apparatus transmits a new communication to the second storage device.

The apparatus of the present invention intercepts a communication from a computer, analyzes the information within the communication, transmits the communication to a first storage device, generates a new communication, transmits the new communication to a second storage device, and reports the results back to the computer. The apparatus may include a software package for carrying out these functions.

Intercepting may be performed by the interceptor and/or adapter cards connected to the interceptor. Analyzing may be performed by the software program. Transmitting the communications may be performed by the interceptor and/or the adapter cards. Generating new communications may be performed by the software program, and reporting may be performed via adapter cards. These and other means for performing these functions are described below.

A “storage device” can mean a disk drive, a memory-based storage system, an optical disk, or a logical partition within a data storage device and may include more than one “first” storage device and/or more than one “second” storage device.

A “communication” can mean one or more communications, and may include commands and/or data. Command data blocks, or CDBs, are examples of such communications.

A “new communication” can be similar to or different from the original communication. For example, if the original communication includes commands and data, the new communication may also include commands and data, or it may just include commands or it may just include data. In any case, the commands and/or data in the new communication may differ from those of the original communication. More than one new communication may be generated. Both the original communication and the new communication may depend on the specific action taken.

The primary benefit of this invention is to implement data protection methods such as data mirroring and replication on existing data storage devices without modifying the original storage device or moving the original data from the original data storage device. This technique is also transparent to the computer because no software or drivers are added, removed, or modified. The only modification that is required is to the physical connections between the computer and the original data storage device, and the addition of one or more secondary data storage devices.

Data mirroring and replication are merely two examples of data protection actions or tasks that can be implemented with the LUN intercept method. This intercept method can also be used for other purposes that require leaving intact the existing and future data on the original data storage device while intercepting and/or analyzing incoming storage commands to determine what future actions may be taken on both the original and secondary data storage devices.

Additional advantages of the invention will be set forth in the description which follows, and in part will be apparent from the description, or may be learned by practice of the invention. The advantages of the invention may be realized and obtained by means of the instrumentalities and combinations particularly pointed out in the appended claims.

### BRIEF DESCRIPTION OF THE DRAWINGS

The accompanying drawings, in which like reference numerals represent like parts, are incorporated in and constitute a part of the specification. The drawings illustrate presently preferred embodiments of the invention and, together with the general description given above and the detailed description given below, serve to explain the principles of the invention.

FIG. 1 is a block diagram of a conventional computer network connected to a storage device;

FIG. 2 is a block diagram illustrating a system for protecting stored data in accordance with an embodiment of the present invention;

FIG. 3 is a diagram illustrating the concept of partitions;

FIG. 4 illustrates a system for protecting data stored on two storage devices using a single storage device in accordance with an embodiment of the present invention;

FIG. 5 illustrates a system for protecting data stored on one storage device with two partitions using a single storage device in accordance with an embodiment of the present invention;

FIG. 6 illustrates how software is integrated into the system of FIG. 2 in accordance with an embodiment of the present invention;

FIG. 7 illustrates a proprietary data block in accordance with an embodiment of the present invention;

FIG. 8 is a flowchart depicting data mirroring in accordance with an embodiment of the present invention;

FIGS. 9A and 9B are flowcharts depicting data replication in accordance with an embodiment of the present invention; and

FIG. 10 illustrates how storage commands are generated for execution on a secondary device in accordance with an embodiment of the present invention.

### DETAILED DESCRIPTION

The following terminology will be used in this disclosure:

“Data server” represents all the different variety of servers, which includes file servers, application servers, web servers, video servers, and all other server types.

“Data storage system” is any type of storage device used in the storage and/or retrieval of data. It includes systems such as disk drives, memory-based storage systems, optical disks, JBODs (Just a Bunch Of Disks), and RAID (redundant array of independent disks) arrays. Logical partitions within a data storage device can be viewed as separate data storage systems, thus one data storage device may comprise two or more data storage systems.

“Intercept” means the capture of commands and/or data that are sent to, retrieved from, or stored on an original data storage device.

“Interceptor” is the generic term for a storage server or any type of processing device that runs the LUN intercept method. The processing device can be, for example, but is not limited to, a computer, microprocessor, digital signal processor, and embedded controller.

“LUN” or “Logical UNit” is a data storage system.

“Original data storage device” is the storage device that is originally connected to the data server before the interceptor is installed between them.

A “request” is a data packet that contains command(s), parameters, and data that instruct the receiver of the request to perform a desired action. The following are types of requests:

1. “File I/O requests” are sent by software applications to the operating system to perform read and write operations on files stored on a storage device.

2. “I/O requests/commands” (also called I/O Request Packets or IRPs) are sent by an operating system to a device driver to perform read and write operations on a storage device. (“IRP” is a term used in the Microsoft Windows operating system; “buf” and “hacb” are used in the Unix and NetWare operating systems, respectively. This disclosure will use IRP generically to refer to all forms of this type of I/O request.)

3. “Storage I/O requests” are sent by the device driver to a data storage device to perform read and write operations. (The term “storage command” will be used interchangeably in this disclosure to mean a “Storage I/O request.”)

4. Other types of requests include retrieving identification information, setting operating parameters, and many others.

“Secondary storage device” is the new, separate data storage device that is connected to the interceptor.

After the LUN interceptor has intercepted a storage request that a data server had sent to an original storage device, the request is analyzed, and then the interceptor (1) executes the original request on the original storage device; (2) may immediately execute a similar request on the new storage device; and/or (3) at a later time, executes a similar request or an entirely different request on the secondary storage device which will be appropriate in relation to the requirements of the applied feature to the original storage device.

Using data mirroring as an example, an interceptor running the LUN intercept method is put into place to intercept the storage requests. If the storage request is to “write data,” the interceptor sends the original request to the original storage system for execution and also creates a new request to write data to a second storage system that will contain the mirrored data. If the storage request is to “read data,” the interceptor receives the request first and may send the original request to the original storage device or may send a new request to the secondary storage device for the most efficient execution of the “read” request.

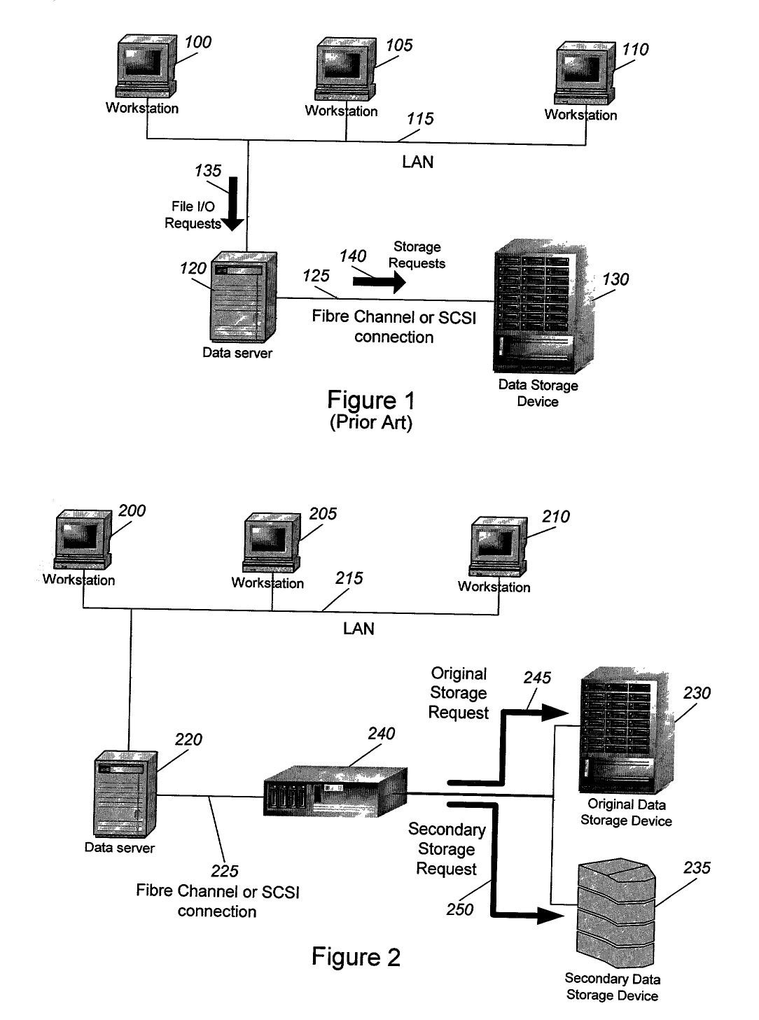

A typical computer network is shown in FIG. 1, in which three workstations 100, 105, 110 are connected over LAN 115 to computer (e.g., file server or data server) 120, to which is connected data storage device 130 via communication path 125, which may be, for example, a Fibre Channel or SCSI connection. Workstations 100, 105, 110 send file I/O requests 135 to data server 120 to either write data to or read data from data storage device 130. File I/O requests 135 are file level command abstractions that make commands to software applications generic, which allow the applications to be ignorant of how data files are organized on disk or how data is accessed from a storage device. Data server 120 receives these file I/O requests and its host operating system converts them to low-level I/O requests (IRPs). The IRPs are received by a device driver and are converted into one or a series of storage requests (or commands and/or steps) 140 which are appropriate for the storage device type and are required to satisfy the IRP.

Shown in FIG. 2 is a block diagram of an LUN intercept system in which interceptor 240 is inserted into the communication path 225 between data server 220 and original data storage device 230. The interceptor now receives the storage commands from data server 220 that were originally bound for storage device 230. Communication path 225 in this example is a SCSI or Fibre Channel connection. Although SCSI and Fibre Channel are used as examples in this disclosure, the LUN intercept method can be implemented using any storage protocol because the interceptor merely has to emulate the behavior of an actual storage device. For example, iSCSI (“Internet SCSI,” also known as “Storage over IP”) is a new standard for storage devices, and the LUN intercept method can be implemented to intercept the commands and data running this protocol. As far as data server 220 is concerned, interceptor 240 acts as storage device 230 would. Interceptor 240 analyzes, manipulates, and/or redirects any storage command to satisfy the “intent” of the request from data server 220.

The “intent” of a request or command is based on the requested task or action and the information extracted from the original command request and is used to determine how the command to the secondary storage device (i.e., the “second” command) should be created. An “intent” is essentially a determination of the actual purpose of a request relating to a task. For example, if interceptor 240 receives a “write” request and the data protect task is “mirroring,” then the request's “intent” is to send a command to write data to original storage device 230 and also to write the same data to secondary storage device 235.

This disclosure uses the terms “request” and “command” throughout. The information in a command and a request may be identical. A “request” is used to describe the information received by interceptor 240 from data server 220, while a “command” is the information that is sent to storage device 230 or 235 for execution. The request and command are identical if they are destined for original storage device 230. However a command sent to secondary storage device 235 will likely differ from the request.

FIG. 2 shows original storage device 230 and secondary storage device 235 attached to interceptor 240. If interceptor 240 is configured for data mirroring, interceptor 240 will transparently execute the original request on original storage device 230 and the same request intent on secondary device 235, unbeknownst to the data server 220. The interceptor analyzes the nature of the command, creates a similar command that is compatible with the type and geometry of secondary device 235, and executes the command. For example, if the nature of the command is to write data, yet the storage protocols running the original and secondary devices are not the same, the requests to both devices will be “write,” but request 245 to original storage device 230 may be written in Fibre Channel protocol and request 250 to secondary storage device 235 may be written in SCSI protocol.

The LUN intercept method is capable of implementing its features on two levels on an entire logical storage device or on a discrete logical partition. A logical device is a storage device that may be composed of one or more physical devices that act as one. The storage area of a logical device can be subdivided into one or more partitions. A “logical partition” is one or more partitions that are grouped together before a file system is created within it. A computer views each logical partition as a separate disk drive. After a file system such as FAT, FAT32, NTFS, or UNIX is established, then the partition is also known as a “volume.”

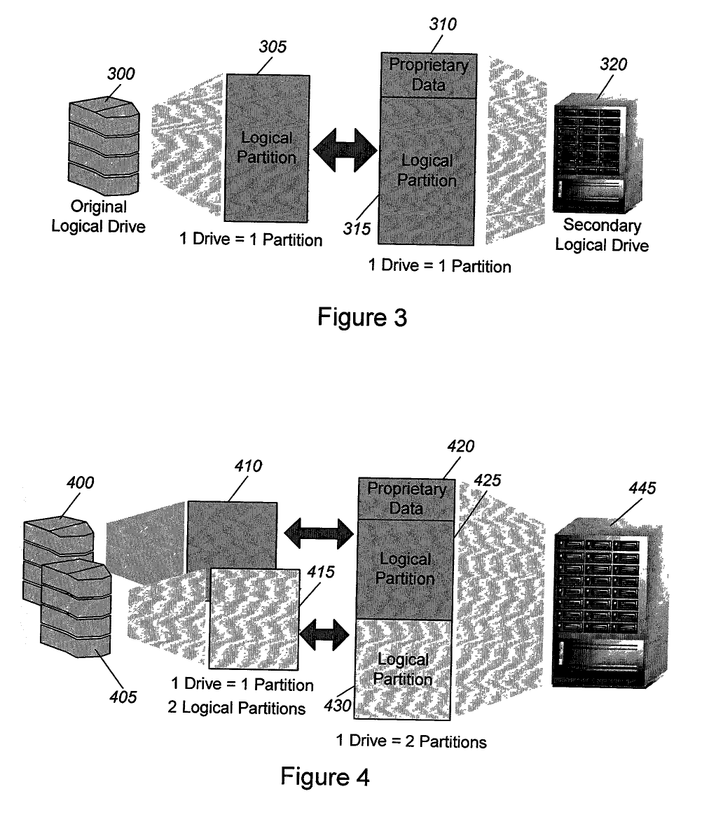

The concept of partitions is illustrated in FIG. 3. Two storage devices are shown in which the original device 300 may be, for example, a 100 MB storage device and is linked to a secondary 100 MB storage device 320 from another manufacturer. Original device 300 already contains data. Secondary device 320 is a newly connected device that will contain data related to the data on original device 300. If secondary device 320 is to contain all the data that is either a copy of or derived from original device 300's intercepted storage commands and data, or is retrieved (read) from the original drive 300 itself, then the total capacity 310 plus 315 of secondary device 320 must be greater than the capacity 305 of original device 300.

This additional disk space contains proprietary data 310 that LUN interceptor 240 must store about secondary device 320 starting at the beginning of the drive. Proprietary data 310 is discussed in more detail later in reference to proprietary data blocks.

If secondary drive 320 only contains a portion of data that is either a copy of or derived from the original drive 300's intercepted storage commands and data, or is retrieved (read) from original drive 300 itself, then secondary drive 320's capacity is not required to be larger than original drive 300's capacity so long as there is enough additional capacity to store proprietary data 310.

Because the proprietary data is stored at the beginning of storage device 320, the sector addresses at which the data reside on device 320 are not the same as those on device 300. Because the sector addresses are not a one-to-one match, the original storage command is only executed on original device 300, and related storage commands for secondary device 320 must be created.

FIG. 4 illustrates another supported feature of the LUN intercept method in which data protection is extended from two original storage devices 400, 405 onto a single, secondary storage device 445. The capacity of secondary storage device 445 must be larger than that of the two original devices 400, 405 combined if secondary device 445 is to contain all the data from original devices 400, 405. The data 410 from first original device 400 are written to one partition 425 of secondary device 445 and the data 415 from the other original device 405 are written to second partition 430. Proprietary data are written into first sector area 420 of secondary device 445.

The secondary drive/partition may or may not be accessible to the data server as an additional device. This depends on the type of task performed on the secondary drive/partition. If the secondary drive/partition is used as a mirror, then the data server will not be aware of the existence of the secondary drive/partition. However, if the secondary drive/partition is a replica of a primary drive/partition, then the secondary system may be viewable and accessible by the data server. The user determines whether a secondary drive/partition is accessible by setting the proper parameters on interceptor 240.

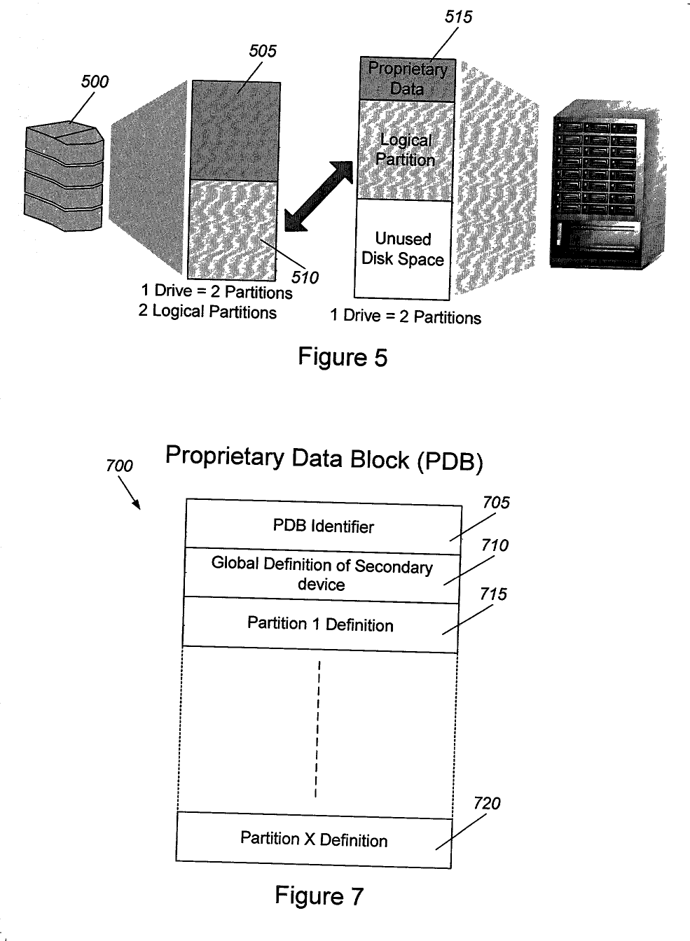

Another example of an LUN intercept configuration/combination is illustrated in FIG. 5. One original device 500 has been partitioned into two or more logical volumes 505, 510. The LUN intercept method can be applied to all partitions or to selected partitions within the original device(s) in copying the data to the secondary device(s).

The remainder of this disclosure assumes that the storage devices are SCSI-based and therefore use SCSI Command Data Blocks (CDBs) to deliver commands and data. Previously, it was stated that the connections between the data server and the interceptor could either be SCSI, Fibre Channel, or one of several other protocols. These refer to the medium type and transport protocol that is used. However both SCSI and Fibre Channel use SCSI CDBs as their underlying command data structure (or blocks) for conveying their instructions. Other and future methods of conveying storage instructions may rely on the same basic principles, which include sending and/or receiving sequences of blocks or bytes of command and/or data information, which are received by a data storage device in which the commands are processed and executed. The LUN intercept method is also applicable with those methods.

A SCSI CDB is a standardized data structure that has been sanctioned by the I.E.E.E (Institute of Electrical and Electronics Engineers) for transmitting a command and its parameters to a SCSI-compatible storage device. There are many storage commands that have been defined for a SCSI CDB to represent, but this disclosure illustratively focuses on two commands, read and write.

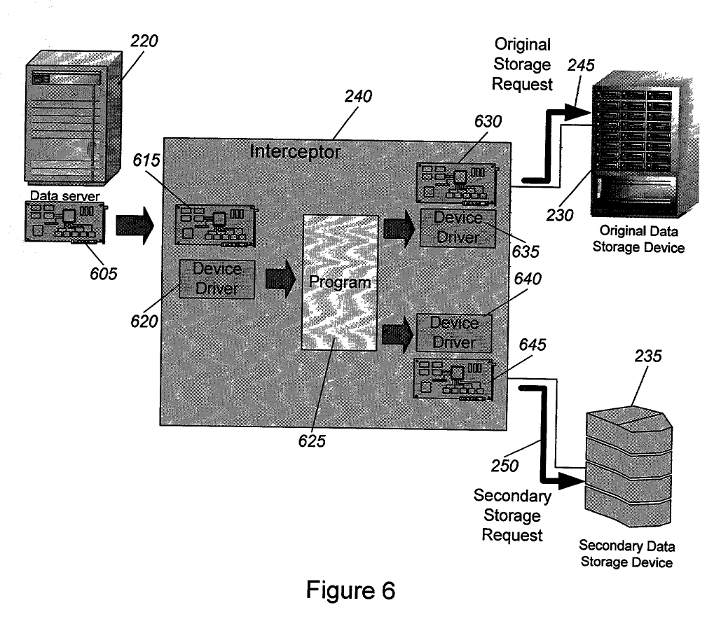

FIG. 6 is a more detailed view of the diagram of FIG. 2, showing lower level software and hardware that interact with interceptor 240. Interceptor 240 communicates with data server 220 via adapters 605, 615. Similarly, interceptor 240 communicates with storage devices 230, 235 via adapters 630, 645, respectively. Interceptor 240 also includes a software program 625 that controls its operation. Program 625 can be one or a series of programs that are implemented on the kernel level or application level or both. Program 625 can also include specially modified or created device drivers 620, 635, 640 that are used to drive their associated adapters 615, 630, 645. Program 625 (1) configures intercepting host adapter 615 as a receiver of storage commands and data; (2) manages the reception of CDBs and data from data server 220; (3) analyzes the command/data information; and (4) executes the original CDB and data on original storage device 230.

Next, based on the requirements of the specific task and the originally-issued CDB, program 625 generates new, equivalent CDB(s) and executes the new CDB(s) and data on secondary storage device 235. New, equivalent CDBs may or may not be similar to the originally issued CDB. For example, a minimal change could be a modification of the sector address information that was in the original CDB so that it can be used in the new CDB. The command and other information would be carried over from the original CDB to the new CDB. A drastic change may require a totally different command or a series of commands to be generated for execution on secondary storage device 235. Therefore the new CDB(s) may be totally different from the original CDB, but will satisfy the requirements for the task.

In addition, based on the requirements of the specific task, program 625 may then generate new CDB(s) to be executed on original storage device 230 to support the execution of CDBs on secondary storage device 235. The new CDB(s) destined for original storage device 230 can perform any type of operation except operations that will cause data to be changed or moved on original storage device 230. For example, if the task is replication, new CDBs will be generated that read data from original storage device 230 so that data are available to be written to secondary storage device 235. If there are additional secondary storage devices (not shown), program 625 continues generating and executing new CDBs for each secondary device. The program manages the completion status and error status of each command and performs any necessary error reporting and error handling that may be needed. Finally, program 625 reports back to data server 220 with any errors that data server 220 itself needs to deal with.

Program 625 is capable of performing autonomous or scheduled operations as well as in-step (synchronous) operations. An example of an in-step operation is mirroring where commands such as “write” must be executed on secondary storage device 235 directly after the original command is executed on original device 230, and before program 625 responds back to data server 220 with the proper status. Replication is an example of a scheduled operation in which a copy of original storage device 230 or a logical partition within storage device 230 is to be made to secondary storage device 235 at scheduled intervals.

Program 625 is also capable of intelligent decision-making such as determining the most effective method of executing a command. For example, in a mirrored data storage system containing storage devices 230, 235, it is not efficient to read data from only one storage system 230, especially because there is a secondary storage system 235 that contains the exact same data. Program 625 can distribute the read operations to both storage systems 230, 235 to take advantage of using two channels 630, 645 to retrieve the data faster.

In order to install the LUN interceptor, the data server and the original data storage device must be disconnected from each other and then reconnected to interceptor 240 as shown in FIG. 2. Next, secondary storage device 235 is connected to interceptor 240. After the physical connections have been established, interceptor 240 is powered up and program 625 starts running. Program 625 locates and records into its database all the attached storage devices.

An interface (not shown) may be provided to configure the interceptor with its operating parameters. The interface is preferably a software program that either runs on interceptor 240 or another computer that communicates with the interceptor. Operating parameters may include determining (1) which of the storage devices are the original devices; (2) which are secondary devices; (3) which original device or original logical partitions are to be intercepted; (4) the type of interception (of which mirroring and replication are examples); and (5) how the original devices/partitions and secondary devices/partitions are to be paired off.

If the interface is not used to set any of the above parameters, interceptor 240 can operate using default settings which may assume that all the attached storage devices are original, allowing the data server to access all the storage devices. Because the data, including the partition tables, on the original data storage device have not been altered, the data server can use the original storage devices via interceptor 240 as it has done before. The data server is not aware of the interceptor. The new storage devices will also appear to the data server as additional storage devices, which are fully accessible.

After the interface indicates which of the storage devices is/are original, interceptor 240 records this information into a database. This database is a special file that resides on interceptor 240 and is used to record all information necessary for the LUN intercept task to function properly. The LUN intercept task reads the database when the task starts up to learn how all the devices interoperate and the devices' operating parameters. The task may also update the database with new information during the task's operation. The information in the database can be used for a wide variety of purposes such as to prevent users from making errors and to provide helpful information when setting up the LUN intercept tasks.

After the interface indicates which of the storage devices is/are secondary, interceptor 240 writes a proprietary data block (PDB) onto each secondary storage device in addition to recording the information into the database. Each secondary storage device can continue to be used as primary storage by the data server with the proprietary data block, but, without a PDB, a secondary storage device cannot be used by the LUN intercept method as secondary storage.

A PDB defines how the secondary device is being used and helps to rebuild the database during a disaster recovery event if the database is lost or corrupted. A PDB is a data structure that is stored starting at or near the beginning of a logical disk (see, e.g., proprietary data blocks 310, 420, 515). This logical disk is the secondary data storage device. A PDB is written to each secondary data storage device and it stores information concerning the secondary data storage device, such as geometry data of the secondary device, the definitions for the tasks to be performed on the device, and data to help rebuild pairing links after a disaster recovery event occurs. Because a PDB is a static entity, its data content will not change unless a special circumstance occurs such as a configuration change. A PDB is generally read during the LUN task initialization cycle to validate a secondary data storage device and to retrieve data not provided in the database.

A PDB is accessible only by the interceptor. The data server cannot directly read from or write to this block. FIG. 7 shows a sample PDB 700 that may be stored on the secondary device. One of the first sets of information stored in a PDB is PDB identifier 705. This identifier helps the interceptor identify and confirm that a storage device is a secondary device. Another set of information is the global definition of secondary device 710. This block provides interceptor 240 with information about the overall configuration of the secondary device. PDB 700 also includes a series of partition definition blocks 715-720 that contain information about each partition within the secondary device, such as their own configuration information and the performed task.

If a PDB is accidentally written to an original storage device, then all information on the original device will be lost. Thus, it is important for a user to first indicate to interceptor 240 which storage device(s) is(are) original. Additional precautions to prevent accidental data loss include having the interface perform several checks on the storage device before a PDB is written, if a storage device is not designated as original. An example of a check is a search for a valid partition table. If a valid partition table exists, then legacy data may exist, and the interface informs the user. If the user overrides the warning, the PDB will be written resulting in a possible loss of the data from the device.

After the original and secondary storage devices have been designated, the next step in the LUN intercept process is to indicate which devices and/or partitions are to be intercepted and which task is to be performed. The interface presents the original logical devices and logical partitions for selection. After the device or partition is selected, the interface offers a list of tasks that can be performed and a selection is made. Next, the interface offers a list of secondary (destination) storage devices that are available to contain the data to be stored. The user has the option of selecting the destination storage device or allowing the interface to select a suitable destination device. In either case, the destination device is chosen from the list of secondary storage devices. Once these steps have been taken, interceptor 240 is able to perform its task on the selected device and partitions.

In conventional operation, a data server transmits storage commands and also sends data to and receives data from a data storage device. In the LUN intercept method, an interceptor is inserted into the communication path between the data server and the data storage device such that the interceptor now appears to the data server as the data storage device. As stated earlier, SCSI CDBs are used to illustrate how storage commands are received and processed by the interceptor. Interceptor 240 intercepts the SCSI CDBs and, if the appropriate task is performed on the secondary storage device, creates new SCSI CDBs for execution on the secondary device. Data mirroring is used as the example task for illustrating this process. As mentioned above, SCSI CDBs are data structures that contain commands and parameters that instruct SCSI devices to perform such tasks as reading data from a storage device, writing data to a storage device, telling the storage device to identify itself, and many more.

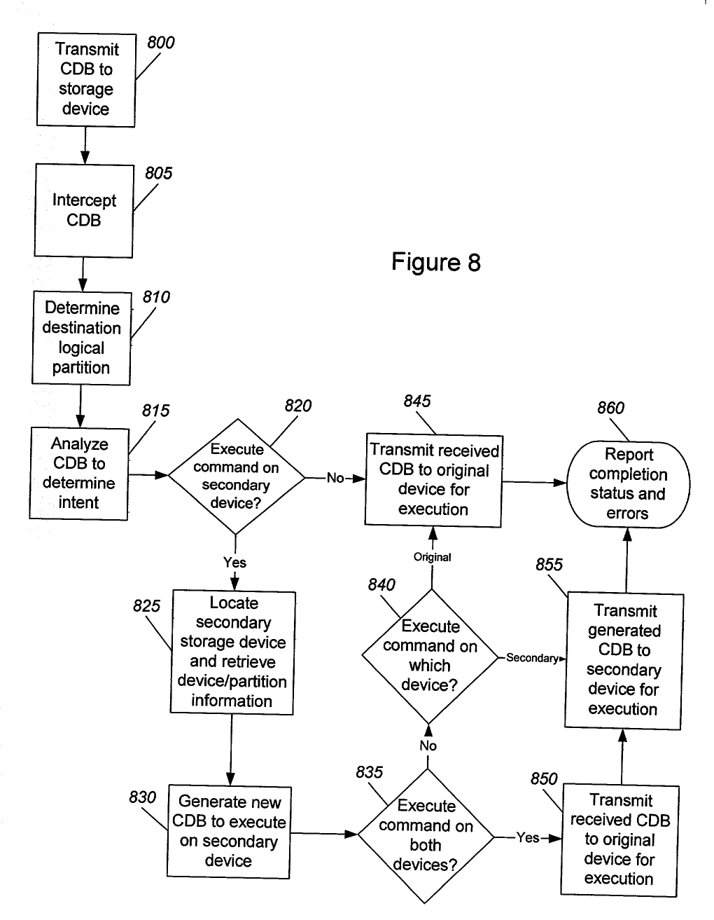

The flowchart in FIG. 8 shows how a new SCSI CDB is generated after an original SCSI CDB is intercepted from the data or file server. The process begins in step 800 with the data server sending a SCSI CDB, which is intercepted by the interceptor in step 805. In step 810, interceptor 240 determines the logical partition on the original device to which the SCSI CDB is destined. Tasks are performed on logical partitions or an entire storage device. Once the destination partition is known, then the task(s) performed on them is(are) known. It is possible for a partition to have more than one task performed on it, and therefore multiple operations may take place when a SCSI CDB is intercepted.

Step 815 determines the intent of SCSI CDB so that interceptor 240 can learn whether operations will take place only on the original device or on both the original and secondary devices. The intent is determined by the command stored in the CDB and the desired task. Commands are divided into three categories:

1. commands executed only on the original device (e.g., “inquiry” command);

2. commands executed on both the original and secondary devices (e.g., “write” command); and

3. commands executed by either the original or the secondary device (e.g., “read” command).

These example commands (inquiry, write, read) apply only if data mirroring is the task to be performed on the original storage device. If a different task is to be performed on the original storage device or partition, then the commands may be categorized differently. These commands are used as examples in this particular discussion to facilitate the explanation of how new CDBs are synchronously generated for execution on the secondary device in connection with a mirroring task.

In data mirroring, commands such as “inquiry” only have to be executed by the original storage device because these types of commands may be determined by interceptor 240, based on the nature of the task, and do not require the secondary storage device. In this case, “inquiry” is a command that requests identification information from the storage device, and since the data server is not aware of the existence of the mirroring storage device and does not need its identification information, the interceptor only executes this command on the original storage device and returns the information to the data server. In the FIG. 8 flowchart, in step 820, because the task is data mirroring and the command is “inquiry,” it is determined that the command does not have to be executed on the secondary device. In step 845, this SCSI CDB is sent to the original device for execution and the results of the command are sent back in step 860 to the data server.

In data mirroring, commands such as “write” are executed first by the original storage device and then by the secondary storage device. Although both devices execute the same command, the parameters within their CDBs are not the same. In most cases, the CDB parameter that is always modified is the sector address, and in some other situations, the modification may also include the sector count. This is because the PDB is located at the beginning of the secondary disk (as shown in FIGS. 3-5) and the partitions on the secondary device may represent data from more than one original device or may be from different areas of a single original device. Therefore, in the FIG. 8 flowchart, for a “write” command in step 820 it is determined that the CDB may need to be executed on the secondary device, after which step 825 retrieves the information concerning the secondary device and its partitions. This information tells interceptor 240 how to access the secondary device and how to create a new CDB. Next, in step 830 a new CDB is generated, and in step 835 the interceptor determines if both CDBs, original and new, should be executed on both devices or on only one of the devices. Because a “write” command is executed on both devices, in step 850 the original CDB is sent to the original device for execution, and in step 855 the generated CDB is then sent to the secondary device for execution. When both CDBs have been executed, in step 860 interceptor 240 determines the proper error status and data to return back to its data server. If the original device is linked to more than one secondary device (not shown in FIG. 8 flowchart), then a CDB is generated and executed on each secondary device, and interceptor 240 determines the proper error status and data after all the CDBs have been executed.

In data mirroring, commands such as “read” can be executed by either the original storage device or by a secondary storage device. If the “read” operation is to be executed on the original storage device, then the originally received CDB is used. If the “read” operation is to be executed on a secondary device, then a new CDB needs to be created. A “read” operation may be executed on either device because of the example task demonstrated in FIG. 8, data mirroring. If two devices are mirrored, then both devices contain exactly the same data at the same moment. Therefore, to increase the data server's perception that the original device is reading data faster, the interceptor will read data from both devices. If one device is busy performing one “read” operation, the interceptor will perform a different “read” operation from the other device. Therefore, from the FIG. 8 flowchart, after the interceptor has determined in step 820 that the “read” operation may be executed on the secondary device and a new CDB is generated in step 830, in step 835 the interceptor decides if the “read” command is to be executed on one device or both. Because the task is data mirroring and the command is “read,” the answer is “one device,” and the interceptor proceeds to step 840 where it decides from which device to retrieve the data. The originally received CDB is executed if it is determined that the original device is the best candidate to perform the operation in step 845. If the secondary device is the best candidate, then the generated CDB is executed in step 855.

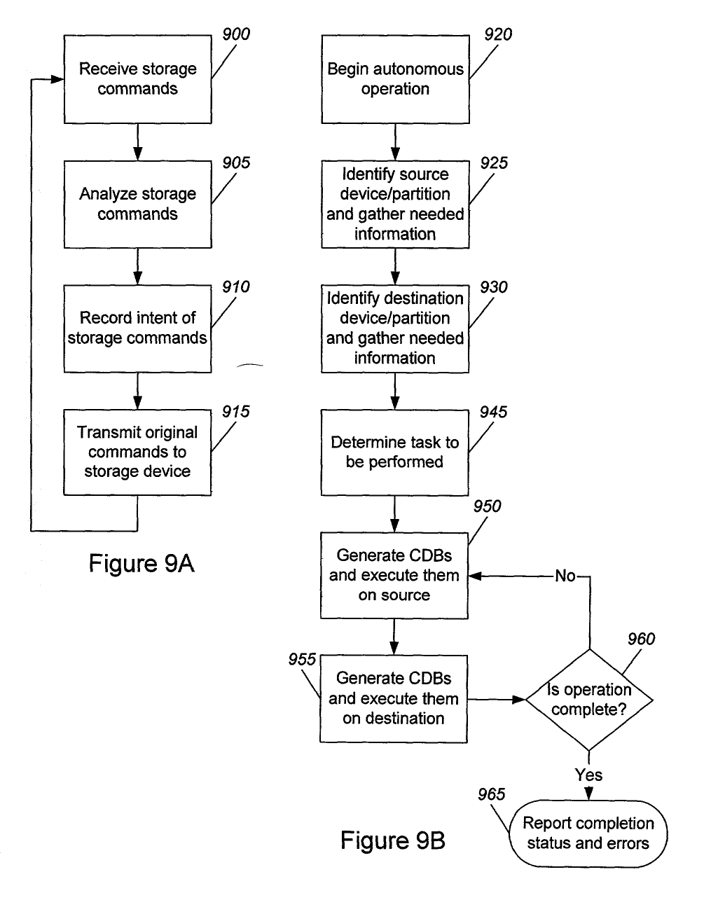

FIGS. 9A and 9B illustrate the replication task in which LUN intercept storage commands are not executed immediately on the second device as discussed with respect to data mirroring. Instead, in step 900 the commands are received by program 625 and analyzed in step 905. Based on the implemented task, specific information on the command's intent is recorded in step 910. For example, if the implemented task is replication, the program may focus only on “write” commands to learn where new data are written on the disk drive. When the actual data replication task starts, the program can differentiate between new data and old data. Instead of copying an entire disk drive or partition, the program only needs to copy to the second storage disk the portions that contain the new data. Once the program has learned what it needs from the received command, the received command is transmitted to the original device for execution in step 915. At some later time, the program in FIG. 9B begins a process in step 920 that performs the task on the secondary device. In steps 925 and 930, the program identifies the source and destination devices or partitions and gathers needed information. In step 945, the program determines the task to be performed. New storage commands (e.g., SCSI CDBs) are created in step 950 to read data from the original device, and new storage commands (e.g., SCSI CDBs) are created in step 955 to write data to the secondary device based on the information the program had gathered when it intercepted the original storage commands in FIG. 9A. Because the original device and the secondary device contain some of the same data, a read command may be executed on either device, but the secondary device should be checked first to see whether the data is on that device. The process continues (step 960) until all the new data is copied to the secondary device, and then in step 965, the program reports completion status and errors to the data server.

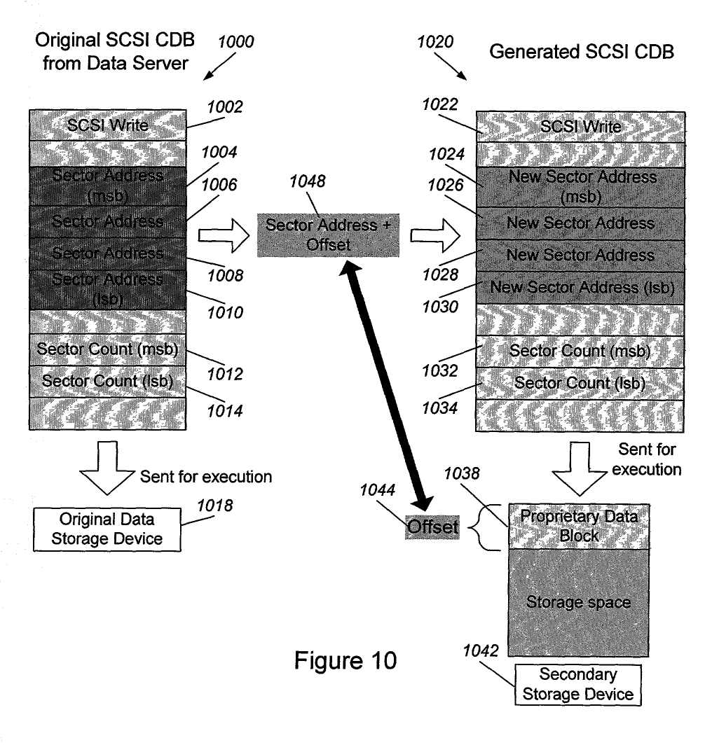

FIG. 10 illustrates in another manner how storage commands are generated for execution on a secondary device 1042 for a data-mirroring task. Program 625 receives a storage command (which in this example is SCSI CDB 1000) bound for original device 1018. SCSI CDB 1000 is analyzed and the actual command is determined. Depending on the actual command, the program may perform a different action. In this example, the received SCSI command is a “write” command 1002. When the program receives a “write” command, the program, at a minimum, extracts the starting sector address 1004-1010 and sector count 1012-1014 from the original CDB to use to determine where data may be written onto secondary device 1042. Next, the identity of secondary device 1042 that is paired to original device 1018 is located and the partition (if any) on secondary device 1042 is determined. FIG. 10 shows only one partition on secondary device 1042 which has an offset 1044 caused by PDB 1038. In this example, the program adds the PDB's offset 1044 to original sector address 1048 to produce a new starting sector address 1024-1030 for new CDB 1020. If the sector block size is the same on original device 1018 and secondary device 1042, then sector count 1032-1034 will remain the same and will simply be stored into new CDB 1020. The original storage command and data are forwarded to the original device for execution. FIG. 10 is a simplified example illustrating how new CDBs are generated. The mathematics for the algorithm become more complicated if sector block sizes are different or if the secondary device consists of a series of smaller capacity devices that are combined together.

The major advantages of the LUN intercept method are:

1. The original and secondary storage devices do not need to be identical in build and capacity. Storage devices from different manufacturers and with different communication protocols (e.g., SCSI or Fibre Channel) can be interfaced together to form new pairs;

2. The method can intercept commands and data under any type of standardized protocol;

3. Almost any type of storage device, including JBODs (Just a Bunch Of Disks), can be used as the original storage device;

4. The method allows new tasks to be implemented with minimal impact on the original storage devices

5. No software or hardware additions need to be made to the data server. The only impact to the data server involves disconnecting the storage device and data server from each other and reconnecting them to the interceptor;

6. No modifications are made to the original data storage device's internal configuration or to the data stored on it;

7. The method can intercept storage commands and data of an entire data storage device or selected partition(s) within the original device; and

8. The method independently manages the data of the entire original data storage device or a selected partition in conjunction with a secondary data storage device.

It must be reiterated that the present invention leaves intact the existing and future data on the original data storage device while intercepting and/or analyzing incoming storage commands to determine what future actions may be taken on both the original and secondary data storage devices. In addition, the examples of tasks performed used in this description, data mirroring and replication, are merely two examples of data protection methods that can be implemented with the LUN intercept method. Other data handling methods that leave the data on the original storage device intact fall within the scope of this disclosure and the appended claims.

Additional advantages and modifications will readily occur to those skilled in the art. Therefore, the present invention in its broader aspects is not limited to the specific embodiments, details, and representative devices shown and described herein. Accordingly, various changes, substitutions, and alterations may be made to such embodiments without departing from the spirit or scope of the general inventive concept as defined by the appended claims.

We claim:

1. A method for protecting data stored on a first storage device, comprising:
intercepting a communication from a computer destined for the first storage device;
analyzing the information within the communication; and
determining whether an action is to be taken regarding the first storage device, a second storage device, or both storage devices.

2. The method according to claim 1, wherein the data on the first storage device are not modified by the action.

3. The method according to claim 1, further comprising transmitting the communication to the first storage device.

4. The method according to claim 3, further comprising transmitting a new communication to the second storage device.

5. The method according to claim 4, wherein the new communication is based on the action and the communication.

6. The method according to claim 1, wherein the action is mirroring data stored on the first storage device to the second storage device.

7. The method according to claim 6, wherein the communication comprises an inquiry command.

8. The method according to claim 7, further comprising transmitting the inquiry command to the first storage device.

9. The method according to claim 6, wherein the communication comprises a write command.

10. The method according to claim 9, further comprising transmitting the write command to the first storage device.

11. The method according to claim 9, further comprising generating an equivalent write command and transmitting the equivalent write command to the second storage device.

12. The method according to claim 6, wherein the communication comprises a read command.

13. The method according to claim 12, further comprising:
determining whether the read command should be transmitted to the first or second storage device;
if the read command should be transmitted to the first storage device, transmitting the read command to the first storage device; and
if the read command should be transmitted to the second storage device, generating an equivalent read command and transmitting the equivalent read command to the second storage device.

14. The method according to claim 1, wherein the action is replicating data stored on the first storage device to the second storage device.

15. The method according to claim 14, wherein the communication comprises an inquiry command.

16. The method according to claim 15, further comprising transmitting the inquiry command to the first storage device.

17. The method according to claim 14, wherein the communication comprises a write command.

18. The method according to claim 17, further comprising transmitting the write command to the first storage device.

19. The method according to claim 17, further comprising generating at a later time an equivalent write command and transmitting the equivalent write command to the second storage device.

20. The method according to claim 14, wherein the communication comprises a read command.

21. The method according to claim 20, further comprising:
determining whether the read command should be transmitted to the first or second storage device;
if the read command should be transmitted to the first storage device, transmitting the read command to the first storage device; and
if the read command should be transmitted to the second storage device, generating an equivalent read command and transmitting the equivalent read command to the second storage device.

22. The method according to claim 1, further comprising reporting results of the action to the computer.

23. The method according to claim 1, wherein the communication operates under a Fibre Channel protocol.

24. The method according to claim 1, wherein the communication operates under a small computer systems interface (SCSI) protocol.

25. The method according to claim 1, wherein the communication operates under an Internet small computer systems interface (iSCSI) protocol.

26. The method according to claim 1, wherein the communication comprises a command data block (CDB).

27. The method according to claim 26, wherein the CDB comprises data and at least one command.

28. A method for protecting data on a storage device, comprising:
placing an apparatus in a communication path between a computer and the storage device, wherein the storage device is associated with the computer;
intercepting a communication intended for the storage device; and
transmitting the communication to the storage device.

29. The method according to claim 28, wherein the data on the first storage device are not modified.

30. The method according to claim 28, further comprising:
attaching a second storage device to the apparatus;
analyzing the information within the communication; and
transmitting a new communication to the second storage device.

31. The method according to claim 30, wherein the new communication is based on the information within the communication.

32. The method according to claim 30, wherein the communication and the new communication comprise commands and data.

33. The method according to claim 32, wherein the transmitting to the first and second storage devices comprises executing commands on the respective storage device.

34. The method according to claim 28, further comprising transmitting to the computer results based on the communication.

35. A system for protecting data on a storage device, comprising:
a computer in communication with the storage device via a communication path; and
an apparatus placed in the communication path between the computer and the storage device,
wherein the apparatus intercepts a communication intended for the storage device and then transmits the communication to the storage device.

36. The system according to claim 35, wherein the data on the first storage device are not modified.

37. The system according to claim 35, further comprising a second storage device in communication with the apparatus, wherein the apparatus transmits a new communication to the second storage device.

38. The system according to claim 37, wherein the communication and the new communication comprise commands and data.

39. The system according to claim 38, wherein the transmitting to the first and second storage devices comprises executing commands on the respective storage device.

40. An apparatus for protecting data on a first storage device, comprising:
means for intercepting a communication from a computer;
means for analyzing the information within the communication;
means for transmitting the communication to the first storage device;
means for generating a new communication;
means for transmitting the new communication to a second storage device; and
means for reporting results back to the computer.

41. The apparatus according to claim 40, further comprising a software package for protecting the data.

42. The apparatus according to claim 40, wherein the communication and the new communication comprise command data blocks (CDBs).

43. The apparatus according to claim 42, wherein the CDBs comprise commands and data.

44. The apparatus according to claim 43, wherein the transmission to the first and second storage devices comprises executing the commands on the respective storage device.
